(19) United States
(12) Patent Application Publication
(10) Pub. No.: US 2005/0136767 A1
(43) Pub. Date: Jun. 23, 2005

(54) Advanced anisotropic ceramic matrix composite system

(75) Inventors: Daniel Peter Ivkovich JR., Fairfield, OH (US); Andrew Jay Skoog, West Chester, OH (US); Jane Ann Murphy, Franklin, OH (US); Thomas Walter Rentz, Cincinnati, OH (US)

Correspondence Address: MCNEES WALLACE & NURICK LLC, 100 PINE STREET, P.O. BOX 1166, HARRISBURG, PA, 17108-1166, US

(73) Assignee: General Electric Company, Schenectady, NY (US)

(21) Appl. No.: 10/738,189

(22) Filed: Dec. 17, 2003

(51) Int. Cl. B32B 27/12; B32B 18/00; B32B 27/04

(52) U.S. Cl. 442/265; 442/64; 442/74; 442/77; 442/178; 442/239; 442/242; 427/385.5; 427/407.1

(57) ABSTRACT

A ceramic matrix composite system includes multiple stacked layers of ceramic fiber cloth impregnated with resin matrix material. The resin matrix material in each of the fiber cloth layers substantially remains with the same layer during subsequent processing. Ceramic-containing material inner layers are applied between each of the fiber cloth layers enhancing the cross ply strength of the composite system.

### BACKGROUND OF THE INVENTION

The present invention relates generally to a ceramic matrix composite system. Specifically, the present invention relates to a ceramic matrix composite system for high temperature service and method for producing the ceramic matrix composite system.

In some applications, a structural part is exposed to high surface temperatures on a heated surface of the part such as in turbine engines used in aircraft. These structural part constructions, such as ceramic matrix composites (CMCs), provide structural support for components associated with engine exhaust, and possibly the engine itself

Typically, CMCs are composed of multiple woven fiber fabric material layers impregnated with an amount of matrix material, often referred to as a prepreg. The fabric layers are arranged to define a desired shape and then subjected to an elevated temperature under slight pressure typically applied by a vacuum bag, typically referred to as debulking, to bond the fabric layers to one another. After debulking, the fabric layers are then placed in an autoclave which exposes the fabric layers to high temperatures and pressure to produce the desired component.

The fiber material in these fabric layers are extremely strong in directions that place the fibers in tension, and the impregnated resinous matrix material, such as found in aluminum oxide-based glass ceramic systems, surrounding the fabric layers provide strength in cross directions to the fibers. However, CMC systems suffer from low strength in the regions between adjacent woven fabric material layers which limits their mechanical performance in cross-ply strength. Their load-handling capability in the direction transverse to the direction of the fibers is limited.

In a typical CMC system, such as a resin bleed system, the fiber layers are subjected to raised temperature and pressure, and resin matrix material flows or bleeds between adjacent fiber material layers. To promote the desired matrix material flow between adjacent fiber material layers, the fiber material layers are provided with an overabundance of resin matrix material. Typically, the matrix material flows outwardly from the center of the fiber material layers along the fiber axes toward the ends of the layers while curing, filling voids between adjacent fiber material layers. The matrix material is either expended filling voids or escapes through the ends of the fiber material layers. However, for components having high aspect ratios, that is, components considerably longer in one direction than another, such as the wings of an aircraft, the resin may not have an opportunity to flow from the center of the component to the end of the component. Additionally, it is difficult to maintain a uniform thickness along the surface of the part. Variations in material thickness adversely affect the strength of the resulting components. While use of matrix materials having enhanced material strength properties is being explored, such enhanced materials reduce the strain carrying properties of the CMC system, making the CMC system less effective than before.

Therefore, what is needed is a CMC material system that has enhanced mechanical performance between adjacent fabric material layers and improved thickness control without resin bleeding between adjacent fabric material layers.

### SUMMARY OF THE INVENTION

The present invention provides a matrix composite system including layers of fiber cloth impregnated with a reduced amount of dry resin content so that during processing, the resin will substantially not bleed from the fiber cloth layers. The amount of dry resin corresponds to a calculated value based on a projected final component ply thickness so that sufficient resin is present to provide structural strength without the need to bleed off resin matrix material. Layers of material having preselected mechanical and structural properties are applied between each adjacent layer of fiber cloth which improve the mechanical properties between the fiber cloth layers. Thus, the resultant composite system will perform with the high strength carrying attributes desired in a composite in the axial direction (direction of the fiber axis) and further have enhanced cross ply strength (direction substantially transverse to the direction of the fibers). This combination of desired properties has not been previously achievable.

One embodiment of the present invention is directed to a matrix composite system comprising at least two layers of impregnated fiber cloth that includes a predetermined amount of impregnated resin matrix material, wherein the resin matrix material of each of the at least two layers substantially remains with the same layer during subsequent processing. A third material layer that includes no axially oriented fibers is applied between each of the at least two layers having similar mechanical and physical properties as the resin matrix material contained in the impregnated fiber cloth.

An additional embodiment of the present invention is directed to a ceramic matrix composite system comprising at least two layers of impregnated ceramic fiber cloth that include a predetermined amount of impregnated resin matrix material, wherein the resin matrix material of each of the at least two layers substantially remains with their respective layer during subsequent processing. A ceramic-containing material layer is applied between each of the at least two layers, the ceramic-containing material layer having similar mechanical and physical properties as the resin matrix material included in the impregnated fiber cloth.

A method of the present invention is directed to producing a component by use of a ceramic matrix composite system, the steps include providing at least two layers of impregnated ceramic fiber cloth with a predetermined amount of dry impregnated resin matrix material, wherein the resin matrix material of each of the at least two layers substantially remains with the respective layer during subsequent processing, applying a ceramic-containing material layer between each of the at least two layers, the ceramic-containing layer having similar mechanical and physical properties as the resin matrix material included in the impregnated fiber cloth; and processing the at least two layers of impregnated ceramic fiber cloth and the ceramic-containing material layer residing between the fiber cloth layers by applying pressure to the at least two layers to produce a desired geometry for the at least two layers and the ceramic-containing material layer; applying a predetermined amount of heat and pressure to the at least two layers and the ceramic-containing material layer; and sintering the at least two layers and the ceramic-containing material layer.

One advantage of the matrix composite system of the present invention is that it provides components having substantially uniform thickness which have enhanced mechanical performance in cross ply strength and in shear.

Another advantage of the matrix composite system of the present invention is that it provides CMC components having substantially uniform thickness irrespective the aspect ratio of the component.

An additional advantage of the matrix composite system of the present invention is that the third material layer may be applied to the opposed outermost surfaces of the outermost fiber cloth layers to provide improved protection for a component having the matrix composite system.

A further advantage of the matrix composite system of the present invention is that the third material layer may be applied in the form a slurry spray, a tape, or may be brushed on the surface of the impregnated fiber cloth.

Other features and advantages of the present invention will be apparent from the following more detailed description of the preferred embodiment, taken in conjunction with the accompanying drawing which illustrates, by way of example, the principles of the invention.

### BRIEF DESCRIPTION OF THE DRAWINGS

FIG. 1 is a cross section of a matrix composite system of the present invention.

### DETAILED DESCRIPTION OF THE INVENTION

The present invention is generally applicable to CMC components that operate within environments characterized by relatively high temperatures, and are therefore subjected to a hostile oxidizing environment and severe thermal stresses and thermal cycling. Notable examples of such components include the high and low pressure turbine nozzles and blades, shrouds, combustor liners and augmentor hardware of gas turbine engines. While the advantages of this invention may be described with reference to gas turbine engine hardware, the teachings of the invention are generally applicable to any ceramic or polymeric matrix composite component that may be constructed of stacked fiber cloth plies impregnated with matrix material.

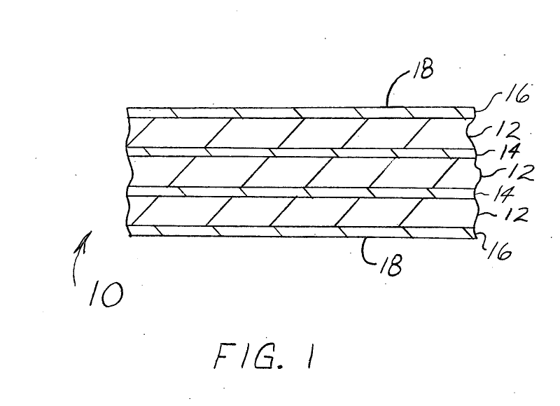

Represented in FIG. 1 is a matrix composite system 10 in accordance with this invention. In a preferred embodiment, the matrix composite system 10 is shown as including a plurality of ceramic prepreg layers 12 having intervening layers 14 inserted between adjacent ceramic prepreg layers 12 to enhance the mechanical properties between adjacent prepreg layers 12 and the overall matrix composite system. Optionally, outer layers 16 are applied to the opposed outermost sides of the outermost prepreg layers 12 forming outer surfaces 18. Upon processing, the thickness of each of the prepreg layers 12 is substantially the same, and the combined thickness of the matrix composite system upon debulking and curing, including the intervening and outer layers 14, 16 are substantially the same along the surface of any components produced by the matrix composite system 10.

Each ceramic prepreg layer 12 is preferably comprised of a woven fabric material layer, or ply that is impregnated with a predetermined amount of ceramic matrix material, which forms a resin when sufficiently heated. However, in contrast to conventional resin bleed CMC systems, wherein an excess amount of ceramic matrix material is applied to each prepreg so that the excess ceramic material bleeds, the matrix composite system 10 uses a reduced amount of dry resin content for each prepreg layer 12. The reduced dry resin content is a calculated value based on a projected ply thickness which will provide sufficient resin in each prepreg layer so that the cross directional ply strength, that is, the strength in a direction substantially perpendicular to the axial direction of the plies or layers, that is the axial direction of the woven fibers, is maintained. By controlling the amount of ceramic matrix material to provide substantially the minimum amount required to achieve cross directional strength, the resulting processed composite matrix maintains high strain carrying attributes and uniform thickness, which is otherwise significantly reduced with bleed CMC systems.

The control of the final thickness of each prepreg layer 12, and collectively of the processed component, which is made possible by the reduced dry resin, provides at least the following several advantages. First, unlike prior art methods since each prepreg layer 12 is not dependent upon other adjacent prepreg layers 12 for resin matrix material, improved material performance is achieved. Second, since the matrix material substantially does not flow between adjacent prepreg layers 12, components having high aspect ratios, that is, ratios where the component length is many times greater than its width, such as a wing of an aircraft, may be produced without the thickness variation of prior art methods. Third, components having complex or elaborate shapes may be constructed while maintaining substantially uniform wall thickness. Fourth, since minimum matrix material is applied, very little, if any, matrix material is wasted due to matrix material flowing from the ends of the prepregs during processing.

Inserted in the interspace between adjacent prepreg layers 12 are intervening layers 14 to provide enhanced strength to the CMC material system. Intervening layers 14 may be applied to adjacent prepreg layers 12 in the form a slurry spray, a tape, or by brush. In a preferred embodiment, tape is applied. U.S. Pat. No. 6,165,600 is directed to applying tape to a substrate and is incorporated by reference. Once the intervening layer 14 is applied, it is debulked and then processed (cured then sintered) to consolidate the ceramic component of the intervening layer 14. According to the invention, the intervening layer 14 is formulated and processed to achieve different mechanical and physical properties compatible with the prepreg layers. Stated another way, ceramic-containing intervening layers 14 are formulated to be formed and processed to provide mechanical properties compatability at elevated temperatures in the interspace between the adjacent prepreg layers 12.

The intervening layer 14 is preferably cast from compositions that contain metal oxide and/or glass particles in an organic matrix that preferably includes one or more binders and/or plasticizers. This layer is formulated to provide thermal expansion capabilities substantially matching with the prepreg layer 12. Controlling the thermal expansion characteristics of the intervening layer 14 is chiefly performed by the use of predetermined blends of preselected ceramic powders. The binders and/or plasticizers are intentionally selected and added in amounts that will create submicron voids in the intervening layer 14 during sintering, which not only promotes the thermal expansion compatibility with the prepreg layer 12, but also a thermal insulating effect. A preferred porosity for the intervening layer 14 is at least 10% (based on weight), with a typical porosity being about 12%, though porosity can be tailored for the particular prepreg material. A suitable thickness for the intervening layer 14 is about 0.001 to 0.011 inch, which typically requires a presintered thickness of about 0.001 to 0.007 inch. More preferably, the thickness for the intervening layer 14 is about 0.001 to 0.003 inch.

Optionally, outer layers 16 may be applied to the opposed outer surfaces 18 of prepreg layers 12. Outer layer 16 may be of similar porosity as intervening layer 14, but may alternately comprise a thin, very dense, smooth formulation that is applied over intervening layer 14. Preferably, outer layer 16 has a surface roughness of less than 20 microinches (about 0.5 micrometers) Ra, typically less than 8 microinches (about 0.2 micrometers), and a porosity of less than 10%. Importantly, the surface finish of the outer layer 16, without further processing, is beyond the capability of spray and PVD processes, and therefore distinguishes ceramic matrix composites coated with an outer layer in accordance with the present invention from the prior art. A suitable thickness for the outer layer 16 is about 0.001 to 0.011 inch (about 25 to 275 micrometers), which typically requires a preprocessed thickness of about 0.001 to 0.015 inch (about 25 to 375 micrometers). More preferably, the thickness for the outer layer 16 is about 0.001 to 0.004 inch (about 25 to 100 micrometers).

The particular compositions for the ceramic intervening and outer layers 14, 16, respectively, can be varied in response to the compositions of the prepreg layer 12 and the environment to which the component will be subjected. Preferred ceramic constituents for the intervening and outer layers 14, 16 include alumina, zirconia, stabilized zirconia and silica. Preferred alumina powders include A-14 (an unground calcined alumina powder; ultimate particle size of 2 to 5 micrometers) and A-16SG (a super-ground thermally reactive alumina powder; ultimate particle size of 0.3 to 0.5 micrometers), both available from ALCOA of Pittsburgh, Pa., and SM8 (ultimate particle size of 0.15 micrometeres) available from Baikowski International Corp. of Annecy, France. Silica can be provided in the form of glass frit or formed in situ during sintering from silicone, which can also serve as a binder prior to sintering. One or more of these ceramic constituents can be included in the tapes used to form the intervening and outer layers 14, 16, respectively. The inclusion of glass and silicon-based materials is desirable from the standpoint of improving the erosion resistance of the outer layer 16. The particle size of the ceramic constituents can be varied, with a suitable particle size range being about 0.02 microinches (about 0.005 micrometers) to about 150 microinches (about 3.8 micrometers). Coarser particles (e.g., A-14) are preferred for the intervening layer 14 to promote strain tolerance, and finer particles (e.g., A-16SG and SM8) are preferred for the outer layer 16 to promote density and surface smoothness.

Broad ranges are stated in weight percents in Table I below for individual constituents that have been combined to produce the ceramic intervening and outer layers 14, 16.

TABLE I
TAPE COMPOSITION FOR:

| | INNER | OUTERMOST |
|---|---|---|
| | LAYER | LAYER |
| Reagent Alcohol | 5-75% | 5-75% |
| PS21A (surfactant) | 0-10 | 0-10 |
| A14 | 5-70 | 0-25 |
| SM8 | 5-70 | 0-25 |
| A16SG | 0-25 | 5-85 |
| SR355 (binder) | 3-35 | 3-35 |
| Dibutyl pthalate (binder) | 0.5-25 | 0.5-25 |
| B-79 (binder/plasticizer) | 1-50 | 1-50 |

Reagent alcohol is included as an evaporable solvent that facilitates the manufacture of the tapes, though other evaporable solvents such as alcohols (e.g., methanol, isopropanol), aldehydes and ketone-base solvents could be used, depending on the system being considered. The solvent is evaporated from the tapes prior to application to the prepreg layer 12 and sintering to form the ceramic intervening and outer layers 14, 16. PS21A is an alkyl organic phosphate ester acid surfactant commercially available from Whitco Chemical of Siloam Springs, Ark., and serves to promote wetting of the alumina particles. The amount of SR355 silicone binder indicated in Table I will yield silica particles in an amount of about 30 to about 40 weight percent of the original amount of SR355 silicone binder present in the tape composition. A like amount of the SR350 silicone binder is capable of yielding silica particles in an amount of about 60 to about 75 weight percent of the original amount of SR350 silicone binder present in the tape composition. This SR350 can be partially or fully substituted for SR355 with additional silica being yielded if needed in a specific application.

A suitable process for forming the tape for intervening and outer layers 14, 16 involves casting the one or more tapes on a tetrafluoroethylene (i.e., Teflon®, which is a registered trademark of E. I. du Pont de Nemours and Company of Wilmington, Del.) sheet. Compositions within the ranges defined above are applied to the Teflon® sheet and then dried for a duration sufficient to evaporate the solvent. The dried tapes are then removed from the Teflon® sheet and transferred to the prepreg layer 12. If multiple tapes are used, the tape or tapes formulated to produce the intervening ceramic layer 14 is applied first, followed by the tape or tapes that form the ceramic outer layer 16. A more preferred process, for a smooth outer layer, is to cast a single multilayer tape that contains at least one layer of each of the compositions of Table I, such that only a single tape application is required. As with the multiple tape approach, the single multilayer tape is applied to the prepreg layer 12 so that the layer formulated to produce the intervening ceramic layer 14 contacts the prepreg layer 12, and the layer formulated to yield the outer ceramic layer 16 is furthermost from the prepreg layer 12. An advantage with using a single multilayer tape is that a lower binder content can be used, resulting in lower porosity of the outer ceramic layer 16.

Following tape application, prepreg layers 12, intervening ceramic layer 14 and outer ceramic layer 16 are debulked, such as by placing the plies in a vacuum bags to aid in the consolidation of the plies to their final dimensional thickness. Pressure is also preferably applied to the outer surface of the tape(s) through the use of a caul plate or other suitable means in order to produce the desired final surface finish and geometry for the outer ceramic layer 16. A vacuum bag can then be used in conjunction with an autoclave to apply the heat and pressure required to chemically or mechanically bond the tape(s) to the prepreg layer 12. The prepreg layer 12, with the attached tape(s) forming an unsintered coating, is then sintered to consolidate and set the ceramic layers 14, 16. Sintering is performed at a sufficiently low temperature that will not adversely affect the desired properties for the prepreg layer 12, but above the temperatures at which the binders and plasticizers will bum off and the ceramic particles form ceramic and glassy bonds. Thereafter, post processing operations can be performed to prepare the component for use.

The individual ceramic layers 14, 16 of the resulting matrix composite system 10 will generally be micrographically discernible, and have morphologies that differ from tape or sprayed ceramic layers. As previously noted, a further distinguishing characteristic of the matrix composite system 10 of this invention is that its surface roughness (i.e., that of the outer ceramic layer 16 ) can be processed to be far lower than that possible with conventionally-used deposition processes—generally 20 micrometers or less as compared to 60 micrometers or more for PVD coatings and much higher for a standard CMC surface finish.

The matrix composite system 10 not only provides enhanced mechanical properties between adjacent prepreg layers 12, but if desired, includes outer coating layer 16 which provides an improved exterior surface that is dense and extremely smooth for improved aerodynamic performance. While a preferred embodiment directed to a ceramic matrix composite system has been discussed, it is contemplated that a matrix composite system for other compositions may also be employed.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A matrix composite system comprising:
at least two layers of cloth, the cloth characterized by a plurality of fibers arranged in a plane and adjacent to each other, each layer including a predetermined amount of dry impregnated resin matrix material, wherein the resin matrix material of each of the at least two layers substantially remains with the respective layers during subsequent processing; and
a third material layer applied in the interspace between each of the at least two layers, the third material layer having similar mechanical and physical properties as the resin matrix material, and bonded to the adjacent layers wherein the at least two layers and the intervening third material layer are cured to form the composite system.

2. The matrix composite system of claim 1 wherein the matrix composite system is a ceramic composite system.

3. The matrix composite system of claim 1 wherein the combined thickness of the cured composite system has a substantially uniform thickness in a direction perpendicular to a plane including the layers.

4. The ceramic matrix composite system of claim 1 wherein the containing material intervening layer is a slurry spray.

5. The ceramic matrix composite system of claim 1 wherein the containing material intervening layer is an air-assisted spray.

6. The ceramic matrix composite system of claim 1 wherein the containing material intervening layer is a tape.

7. The ceramic matrix composite system of claim 1 wherein the intervening material intervening layer is formed of a first particulate material and having submicron voids therein, the sintered intervening layer having a porosity of at least 10 %, the first particulate material being selected from the group consisting of crystalline metal oxides and glasses.

8. The ceramic matrix composite system of claim 7 further including opposed outer surfaces and comprising a ceramic-containing material outermost layer applied to at least one of the opposed outer surfaces of the composite system.

9. The ceramic matrix composite system of claim 8 of the wherein at least one of the opposed outer surfaces of the at least one ceramic-containing material outermost layer is overlaid with the ceramic-containing material layer formed of a second particulate material different from the first particulate material, the sintered outermost ceramic layer having a surface roughness of less than 20 microinches Ra, a porosity of less than 10 %, and being thinner and smoother than the sintered ceramic inner layer.

10. The ceramic matrix composite system of claim 1 wherein the ceramic-containing material intervening layer is from about 0.001 to about 0.011 inches thick.

11. The ceramic matrix composite system of claim 1 wherein the ceramic-containing material intervening layer is from about 0.001 to about 0.003 inches thick.

12. The ceramic matrix composite system of claim 8 wherein the ceramic-containing material outermost layer is from about 0.001 to about 0.011 inches thick.

13. The ceramic matrix composite system of claim 8 wherein the ceramic-containing material outermost layer is from about 0.001 to about 0.004 inches thick.

14. A method of producing a component by a ceramic matrix composite system, the steps comprising:
providing at least two layers of impregnated ceramic fiber cloth with a predetermined amount of dry impregnated resin matrix material, wherein the resin matrix material of each of the at least two layers substantially remains with the respective layer during subsequent processing;
applying at least one ceramic-containing material intervening layer between each of the at least two layers, the intervening layer having similar mechanical and physical properties as the resin matrix material;
debulking the at least two layers and the intervening at least one ceramic-containing material layer;
applying pressure to the at least two layers to produce a desired geometry for the at least two layers and the intervening at least one ceramic-containing material layer;
applying a predetermined amount of heat and pressure to the at least two layers and the intervening at least one ceramic-containing material layer; and
sintering the at least two layers and the intervening at least one ceramic-containing material layer.

15. The method of claim 14 further including an additional step, after the step of applying at least one ceramic-containing material intervening layer and before the step of debulking the at least two layers and the intervening at least one ceramic-containing material layer, of
applying at least one ceramic-containing material outermost layer to at least one of the opposed outermost surfaces of the two outermost layers of impregnated ceramic fiber cloth.

16. The method of claim 15 wherein the at least one ceramic-containing material intervening layer is formed of a first particulate material and having submicron voids therein, the sintered at least one ceramic-containing material intervening layer having a porosity of at least 10%, the first particulate material being chosen from the group consisting of crystalline metal oxides and glasses.

17. The method of claim 16 wherein each of the at least one ceramic-containing material inner layer and the at least one ceramic-containing material outermost layer is a tape.

18. The method of claim 16 wherein each of the at least one ceramic-containing material inner layer and the at least one ceramic-containing material outermost layer is a slurry spray.

19. The method of claim 16 wherein each of the at least one ceramic-containing material inner layer and the at least one ceramic-containing material outermost layer is applied by a brush.

20. The method of claim 16 wherein the at least one ceramic-containing material outermost layer is formed of a second particulate material different from the first particulate material, the sintered outermost ceramic layer having a surface roughness of less than 20 microinches Ra, a porosity of less than 10%, and being thinner and smoother than the sintered ceramic inner layer.
